(19) United States
(12) Patent Application Publication
(10) Pub. No.: US 2007/0050844 A1
(43) Pub. Date: Mar. 1, 2007

(54) Methods, systems and computer program products for monitoring a browsing session

(76) Inventor: Pierre Lebel, Cary, NC (US)

Correspondence Address: MYERS BIGEL SIBLEY & SAJOVEC, PO BOX 37428, RALEIGH, NC, 27627, US

(21) Appl. No.: 11/294,169

(22) Filed: Dec. 5, 2005

Related U.S. Application Data
(60) Provisional application No. 60/712,005, filed on Aug. 26, 2005.

(51) Int. Cl. G06F 15/16

(52) U.S. Cl. 726/13

(57) ABSTRACT

Methods, systems and computer program products for monitoring a browsing session executing on a computer system having an operating system are provided. A browsing session to be monitored is identified. The browsing session is associated with a process identifier of the operating system. Events associated with the identified browsing session are captured, including capturing user input received through tasks executing on the operating system having the associated process identifier. At least one of the tasks is not a browser task instance. A transcript of the captured events is generated.

### RELATED APPLICATIONS

This application claims the benefit of and priority to U.S. Provisional Patent Application No. 60/712,005, entitled “METHODS, SYSTEMS AND COMPUTER PROGRAM PRODUCTS FOR MONITORING A BROWSING SESSION,” filed Aug. 26, 2005, the disclosure of which is hereby incorporated herein by reference as if set forth in its entirety.

### BACKGROUND OF THE INVENTION

The present invention relates generally to operation of web pages, and more particularly, to user interaction with such web pages.

As the popularity of the world wide web continues to increase, so does the demand for quality of service, for example, fast connection and refresh rates. Thus, service providers may continue to look for ways to monitor the performance of the service and debug the system for any problems that may arise. Typically, web pages are created using the hypertext markup language (HTML). HTML may be used to create hypertext documents on the World Wide Web and control how the web pages appear on a user display. HTML web pages are dynamically generated based on a multitude of variables and, therefore, are typically very difficult to debug. In addition, performance of a server system providing users access to various web based pages and services may experience performance degradation resulting in a negative experience for a user accessing the web server. Accordingly, provision of a standard quality of service may be hindered by the inability to test the performance of a web service as seen by a user and to identify and correct any bugs that may be present in the HTML code.

One approach to evaluating services provided by content servers or the like providing resources to clients over the internet is to simulate the client's experience interacting with the server. However, it may be difficult and expensive to do such testing consistently over a range of times and a number of tests to obtain useful information given the potential for variability in server performance based on a variety of variables that may not be controllable. As such, it has been proposed to provide a recorder application to record a client browser session and then automatically replay that session. For example, the iOpus Internet Macro from iOpus Software provided for recording of a users interactions with a browser, such as clicks identified by an associated screen position and/or link selected by the user click. The iOpus Internet Macro also provided for limited control over playback, including inserting waits at various times during playback. However, the iOpus Internet Macro had a variety of limitations, such as handling of nested frames and dialog box windows. In addition, the limited editing abilities of iOpus Internet Macro often resulted in failures during replay due to, among other things, the time variable nature of internet content and resultant challenges in retrieving content from servers that may have changed since the recording of the browser session or the identification of which may be dependent on the state of the client device at the time of recording, which may not be identical to the state of the client device on replay or the state of another device attempting to replay the recorded script. In addition, iOpus Internet Macro provided only limited details of a users actions in its recording, which limited the ability to debug errors on replay.

### SUMMARY OF THE INVENTION

Embodiments of the present invention include methods for monitoring a browsing session executing on a computer system having an operating system. A browsing session to be monitored is identified. The browsing session is associated with a process identifier of the operating system. Events associated with the identified browsing session are captured, including capturing user input received through tasks executing on the operating system having the associated process identifier. At least one of the tasks is not a browser task instance. A transcript of the captured events is generated.

In some embodiments, generating a transcript includes determining a level of detail for the transcript and filtering the captured events based on the determined level of detail. A transcript is generated of the filtered captured events. The captured events may be analyzed to determine corresponding user actions associated with the browsing session. Steps may be generated for reproducing the corresponding user actions based on the captured events and the generated steps may be sequenced based on a sequence of occurrence of the corresponding user actions during the browsing session. A recording of the browsing session may be generated based on the sequenced steps.

In other embodiments, generating steps includes identifying a frame associated with at least one of the steps and identifying a nesting relationship of the identified frame with other frames associated with the browsing session. Generating steps may include identifying a user input associated with one of the steps. The user input may include a user designation of a position on a web page or a window associated with the browsing session and/or text input thereto. One or more attributes of an element associated with the user input may be identified and the window associated with the user input may be identified.

In further embodiments, generating a recording is preceded by inserting a delay step between selected ones of the sequenced steps that is configured to delay transition between the selected ones of the sequenced steps on playback of the recording. Generating a recording may be preceded by editing at least one of the generated steps to define a completed condition for the step. The completed condition may be defined as receipt of a download complete signal, a selected delay time after receipt of a download complete signal, a selected delay time after a page change associated with the at least one of the generated steps and/or an estimate of a completed condition based on signals other than a download complete signal received by a browser associated with the browsing session. Generating a recording may be preceded by selecting a playback speed of the recording, the playback speed defining a delay between completion of each step and a beginning of a next step.

In other embodiments, generating a recording is preceded by determining one of the plurality of attributes of the element associated with the user input that is expected to remain unchanged for playback of the recording and selecting the one of the plurality of attributes of the element that is expected to remain unchanged for use in locating the element on playback of the recording. Generating steps may further include assigning a unique identifier as one of the attributes of the element associated with the user input, wherein the unique identifier corresponds to a relative position of the element when the user input was received. Generating a recording may be preceded by determining that all of the attributes of the element associated with the user input other than the unique identifier are not expected to remain unchanged for playback of the recording and selecting the unique identifier of the element for use in locating the element on playback of the recording when it is determined that all of the other attributes are not expected to remain unchanged. A frame may be the element associated with the user input and generating steps may further include identifying the frame associated with the user input and a nesting relationship of the identified frame with other frames associated with the browsing session as the unique identifier of the frame. Generating a record may be preceded by editing at least one of the generated steps including reviewing the transcript of the captured events to determine what to edit in the at least one of the generated steps.

In yet further embodiments, the browsing session is reproduced by playing back the recording of the browsing session. Reproducing the browsing session may include terminating playing back the recording of the browsing session after a selected step of the sequenced steps to return to an intermediate state of the browsing session. It is determined that subsequent events are to be captured to generate new steps for reproducing corresponding subsequent user actions. The subsequent events are captured and steps for reproducing the corresponding subsequent user actions are generated based on the captured subsequent events. The generated steps for reproducing the corresponding subsequent user actions are sequenced including appending the generated steps to steps of the recording preceding the selected step. A new recording is generated based on the sequenced generated steps including the steps for reproducing the subsequent actions.

In other embodiments, the browsing session includes closing a first browser instance associated with the browsing session while continuing capturing events associated with the identified browsing session. One or more of the tasks that is not a browser task instance may be a dialog window that is not generated by a browser associated with the browsing session. A thread of code configured to carry out capturing events and generating steps may be running independently of any browser task instance associated with the browsing session.

In further embodiments, methods for monitoring a browsing session executing on a computer system include identifying a browsing session to be monitored and capturing events associated with the identified browsing session. The captured events are analyzed to determine corresponding user actions associated with the browsing session. Steps for reproducing the corresponding user actions are generated based on the captured events, including identifying a frame associated with at least one of the steps and identifying a nesting relationship of the identified frame with other frames associated with the browsing session. The generated steps are sequenced based on a sequence of occurrence of the corresponding user actions during the browsing session and a recording of the browsing session is generated based on the sequenced steps.

In other embodiments, methods for monitoring a browsing session executing on a computer system include identifying a first browsing session to be monitored and capturing events associated with the identified first browsing session, including capturing user input. The captured events are analyzed to determine corresponding user actions associated with the first browsing session. Steps are generated for reproducing the corresponding user actions based on the captured events. The generated steps are sequenced based on a sequence of occurrence of the corresponding user actions during the first browsing session and a recording of the first browsing session is generated based on the sequenced steps. A second browsing session is executed using the recording and events associated with the second browsing session are captured, including capturing user input. A level of detail for a transcript of the second browsing session is selected. The level of detail designates ones of a plurality of categories of events associated with a browsing session that may be captured. The transcript of the second browsing session is generated by filtering the captured events associated with the second browsing session based on the determined level of detail, the transcript having a level of detail greater than the recording. The transcript is utilized to analyze performance of the recording.

In some embodiments, selecting a level of detail includes changing the level of detail while capturing events during the second browsing session. A third browsing session may be executed using the recording and a level of detail for a transcript of the third browsing session may be selected that is different from the level of detail for the transcript for the second browsing session. Utilizing the transcript to analyze performance of the recording may include editing at least one of the generated steps including reviewing the transcript of the captured events to determine what to edit in the at least one of the generated steps.

In further embodiments, methods for monitoring a browsing session executing on a computer system include identifying a browsing session to be monitored and receiving a selection of one of a plurality of levels of detail for a transcript of the browsing session, the plurality of levels of detail designating different ones of a plurality of categories of events associated with a browsing session that may be captured. Events associated with the identified browsing session are captured, including capturing user input. The transcript of the browsing session is generated by filtering the captured events associated with the identified browsing session based on the selected one of the plurality of levels of detail. Receiving a selection of one of a plurality of levels of detail may include receiving a second selection of a different one of the plurality of levels of detail while capturing events during the identified browsing session. Another browsing session to be monitored may be identified and a level of detail for a transcript of the another browsing session may be selected that is different from the one of the plurality of levels of detail.

In yet further embodiments, methods for monitoring a browsing session executing on a computer system include executing a browsing session using a recording including a plurality of sequenced steps for reproducing user actions and stopping execution of the browsing session at a selected intermediate step of the recording. Execution of the browsing session is resumed without use of the recording, including accepting user input. Events associated with the resumed browsing session are captured, including capturing the user input. The captured events are analyzed to determine corresponding user actions associated with the resumed browsing session and steps for reproducing the corresponding user actions are generated based on the captured events. The generated steps are sequenced based on a sequence of occurrence of the corresponding user actions during the resumed browsing session. An updated recording is generated by appending the generated sequenced steps to ones of the plurality of sequenced steps for reproducing user actions preceding the selected intermediate step.

In other embodiments, methods for reproducing a recorded browsing session on a computer system include opening a main browser task instance for the browsing session and sequentially executing steps for reproducing user actions included in a recording of the recorded browsing session using the main browser task instance. A command is received to open a second browser task instance for the browsing session and a command is received to close the main browser task responsive to execution of at least one of the steps. Sequentially executing the steps is continued using the second browser task instance after closing the main browser task instance. Sequentially executing, receiving and continuing sequentially executing may be carried out by a thread of code running independently of the main browser task instance and the second browser task instance.

In further embodiments, methods for monitoring a browsing session executing on a computer system include opening a main browser task instance for a browsing session to be monitored and capturing events associated with the identified browsing session. Opening of a second browser task instance for the browsing session is detected. Capturing events associated with the identified browsing session is continued after termination of the main browser task instance and a transcript and/or a recording of steps for playback of the captured events is generated. Opening a main browser task instance, capturing events, detecting opening of a second browser task instance and continuing capturing events may be carried out by a thread of code running independently of the main browser task instance and the second browser task instance.

In other embodiments, systems for monitoring a browsing session include a recorder code module configured to initiate monitoring of the browsing session and to generate a sequence of steps for reproducing user actions based on captured events detected during monitoring of the browsing session. A web manager code module is configured to interact with browser task instances associated with the browsing session to detect the captured events during monitoring of the browsing session. At least one browser task instance is associated with the browsing session. The web manager code module and the recorder code module run independently of the at least one browser task instance. A browser window handler code module may be provided operatively coupled to the at least one browser task instance and configured to detect windows opened by the at least one browser task instance and to report the detected windows to the web recorder code module. A dialog box handler code module may be provided that is configured to detect dialog boxes associated with and opened during the browsing session and to report the detected dialog boxes to the web recorder code module.

While described above primarily with reference to methods, it will be understood that computer systems and computer program products are also provided.

### BRIEF DESCRIPTION OF THE FIGURES

FIG. 1 is a block diagram illustrating data processing systems according to some embodiments of the present invention.

FIG. 2 is an exemplary representation of an HTML document that may be used according to some embodiments of the present invention.

FIGS. 3-9 are flowcharts illustrating operations for monitoring, recording and/or playing back a browsing session according to various embodiments of the present invention.

FIGS. 10-17 are block diagrams illustrating the system of FIG. 1 and process flows related thereto under various different usage conditions according to some embodiments of the present invention.

### DETAILED DESCRIPTION OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language or in a visually oriented programming environment, such as VisualBasic.

The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The invention is described in part below with reference to flowchart illustrations and/or block diagrams of methods, systems and computer program products according to embodiments of the invention. It will be understood that each block of the illustrations, and combinations of blocks, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

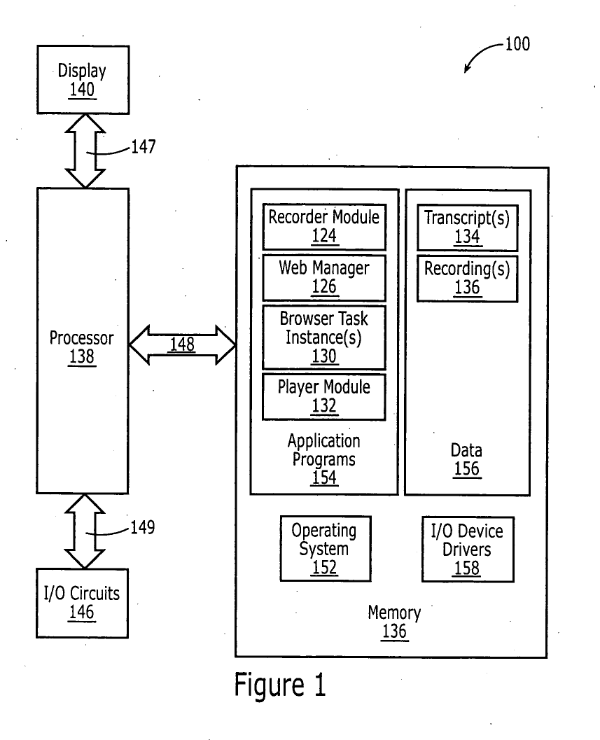

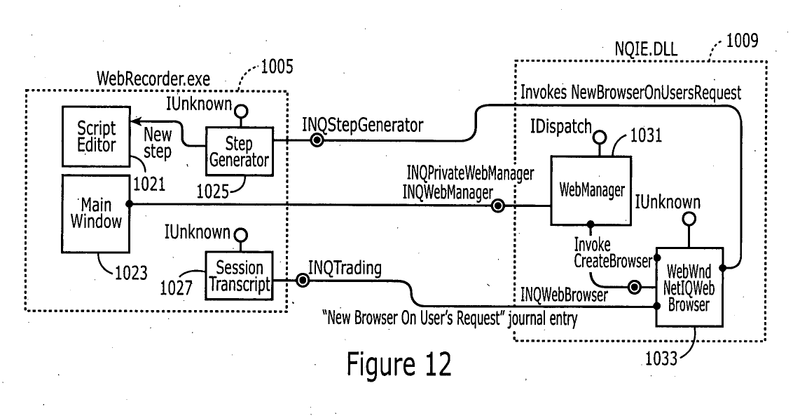

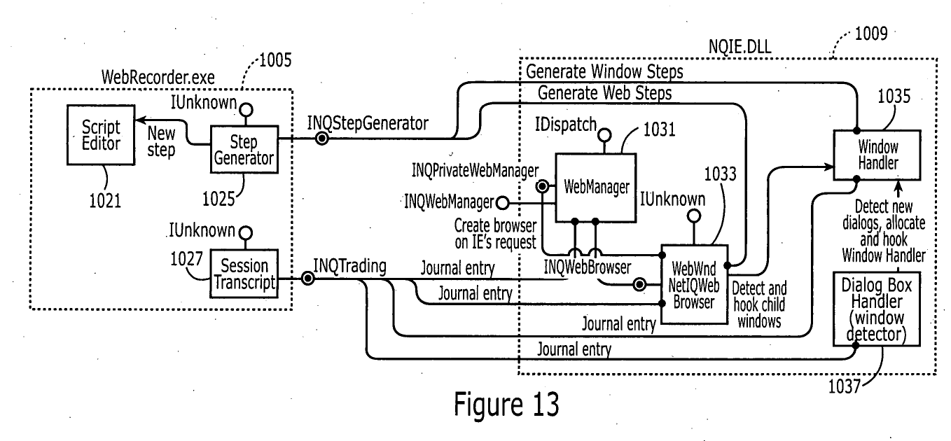

Embodiments of the present invention will now be discussed with respect to FIGS. 1 through 17. As discussed herein, some embodiments of the present invention provided methods, systems and computer program products for monitoring, recording and/or playback of a browsing session. In some embodiments of the present invention, HTML retrieval operations by a user may be monitored and recorded as steps for later playback and such HTML retrieval actions of a browsing session will be utilized at various points herein for purposes of illustration of some embodiments of the present invention. Accordingly, a general description of HTML will be provided by way of background.

A plurality of HTML content elements may be identified for a retrieved web page. As will be discussed further herein, HTML content elements are the basic components of an HTML document. Content elements generally have both a type and a content. An element type, may include, for example, FRAME, FORM, HEADINGS, PARAGRAPHS, LISTS, FONTS, TABLES, and the like. It will be understood that HTML has many defined types of elements and a user may also create new types of elements, thus, embodiments of the present invention are not limited to the examples provided herein or to retrieval of HTML documents.

The content of a content element may be, an attribute, a property and/or a child. A content element attribute may provide a selection criterion defining the manner in which the content elements are to be displayed. If no attribute is specified for a content element, the attribute content may be omitted. A content element property may specify a unique identification (ID) for the content element and map coordinates associated with the content element relative to the particular view on a user's display. Finally, a child of a content element is a content element nested within another (or parent) content element in the HTML code or a content element contained within another content element.

Referring now to FIG. 1, an exemplary data processing system 100 that may be included in devices operating in accordance with some embodiments of the present invention will be discussed. As illustrated, the data processing system 100 includes a display 140, a processor 138, a memory 136 and input/output circuits 146. The data processing system 100 may be incorporated in, for example, a personal computer, server, router or the like. The processor 138 communicates with the memory 136 via an address/data bus 148, communicates with the input/output circuits 146 via an address/data bus 149 and communicates with the display via an address/data bus 147. The input/output circuits 146 can be used to transfer information between the memory 136 and another computer system or a network using, for example, an Internet Protocol (IP) connection. These components may be conventional components, such as those used in many conventional data processing systems, which may be configured to operate as described herein.

In particular, the processor 138 can be any commercially available or custom microprocessor, microcontroller, digital signal processor or the like. The memory 136 may include any memory devices containing the software and data used to implement the functionality circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 may be a content addressable memory (CAM).

As further illustrated in FIG. 1, the memory 136 may include several categories of software and data used in the data processing system 100: an operating system 152; application programs 154; input/output device drivers 158; and data 156. As will be appreciated by those of skill in the art, the operating system 152 may be any operating system suitable for use with a data processing system, such as OS/2, AIX or zOS from International Business Machines Corporation, Armonk, N.Y., Windows95, Windows98, Windows2000 or WindowsXP from Microsoft Corporation, Redmond, Wash., Unix or Linux. The input/output device drivers 158 typically include software routines accessed through the operating system 152 by the application programs 154 to communicate with devices such as the input/output circuits 146 and certain memory 136 components. The application programs 154 are illustrative of the programs that implement the various features of the circuits and modules according to some embodiments of the present invention. Finally, the data 156 represents the static and dynamic data used by the application programs 154, the operating system 152, the input/output device drivers 158, and other software programs that may reside in the memory 136. As illustrated in FIG. 1, the data 156 may include transcripts 134 and/or recordings 136 of browsing sessions for use by the circuits and modules of the application programs 154 according to some embodiments of the present invention as discussed further herein.

As further illustrated in FIG. 1, the application programs 154 include a recorder module 124, a web manager 126, browser task instance(s) 130 and a player module 132 according to some embodiments of the present invention. The recorder module 124 may be configured to initiate monitoring of a browsing session and to generate a sequence of steps for reproducing user actions based on captured events detected during monitoring of the browsing session. The recorder module 124 may also be involved in generating a transcript of the browsing session during monitoring. The web manager module 126 may be configured to interact with browser task instance(s) 130 associated with the browsing session to detect the captured events during monitoring of the browsing session. The one or more browser task instance(s) 130 associated with the browsing session may run independently of the web manager module 126 and recorder module 124 during monitoring and/or playback of a browsing session.

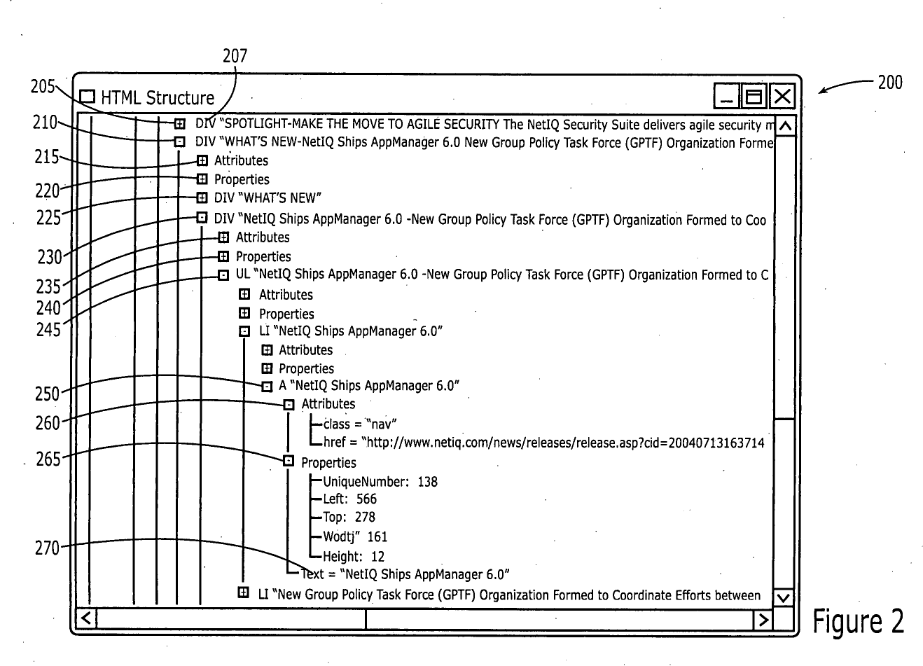

An exemplary hierarchical representation 200 of an HTML document that may be used in generating steps for reproducing a browsing session according to some embodiments of the present invention is illustrated in FIG. 2. As illustrated in FIG. 2, the hierarchical representation 200 of the captured web page includes first and second content elements 205 and 210. As discussed above, content elements generally have both a type and a content associated therewith. As illustrated, both the first and second content elements 205 and 210 have an associated type “DIV” 207. In HTML, the DIV type offers a generic mechanism for adding structure to documents. The DIV type defines content at a block-level, but does not typically impose any other presentational idioms on the content. Thus, the DIV type in conjunction with other attribute types, may be used to tailor the HTML web page documents to user preferences. As discussed above, there are many types of elements provided by the HTML standard, for example, FRAME, FORM, HEADINGS, PARAGRAPHS, LISTS, FONTS, TABLES, and other types may be created, thus, embodiments of the present invention are not limited to the types provided herein for exemplary purposes.

As further illustrated in FIG. 2, the second content element 210 has been expanded to show lower levels of the hierarchy (architecture), thereby illustrating the associated attributes 215, properties 220 and first and second children 225 and 230, i.e., the content portion of the content element. The second child 230 has been further expanded to illustrate the associated attributes 235, properties 240 and child 245 thereof, and so on. As discussed above, attributes may provide a selection criterion defining the manner in which the content elements are to be grouped in the hierarchy and displayed on a user display, for example, display 140 (FIG. 1). If no attribute is specified for a content element, the attribute content may be omitted.

As illustrated in FIG. 2, the attributes 260 of content element 250 include: class “nav” and href=“http://www.netiq.com/news.” The class attribute assigns one or more class names to a content element and, thus, the content element may be said to belong to these classes. A class name may be shared by several content element instances. The “href” attribute indicates a universal resource locator (URL). For example, the href attribute in FIG. 2 creates a link to the web page specified therein.

As further illustrated in FIG. 2, the properties 265 of content element 250 include a unique identification (Unique number: 138) and map coordinates (left, top, width, height) associated with the content element relative to the particular portion of the web page that is visible on a user's display (display 140 of FIG. 1), for example, the browser view. The coordinates may indicate a view of what the user sees on the user display, where a negative number, for example, would indicate a position above the viewed portion of the page. In other words, a first hierarchical representation of a web page may be generated based on a current view of the web page. If the user then scrolls down the web page, a second hierarchical representation of the web page may be generated based on the scrolled view of the web page, where element map coordinates may change while the hierarchy may otherwise remain unchanged. The property coordinates associated with a same content element may be different based on the user's view of the web pages, i.e., original view and scrolled view. A text string 270 may also be associated with the content element 260 as illustrated in FIG. 2.

Examples of methods, systems and computer program products for generating hierarchical representations of web pages are further described in commonly assigned U.S. patent application Ser. No. 11/212,790 (Attorney Docket No. 5670-45) to Lebel, entitled Methods, Systems and Computer Program Products For analyzing a hypertext markup language (HTML) document, filed Aug. 26, 2005, the disclosure of which is hereby incorporated herein by reference as if set forth in its entirety.

While the present invention is illustrated with reference to the recorder module 124, web manager 126, browser task instance(s) 130 and player module 132 being application programs in FIG. 1, as will be appreciated by those of skill in the art, other configurations fall within the scope of the present invention. For example, rather than being application programs, one or more of the modules may also be incorporated into the operating system 152 or other such logical division of the data processing system 100, such as dynamic linked library code. Furthermore, while the respective modules 124, 126, 130, 132 are illustrated in a single data processing system, as will be appreciated by those of skill in the art, such functionality may be distributed across one or more data processing systems. Thus, the present invention should not be construed as limited to the configuration illustrated in FIG. 1, but may be provided by other arrangements and/or divisions of functions between data processing systems.

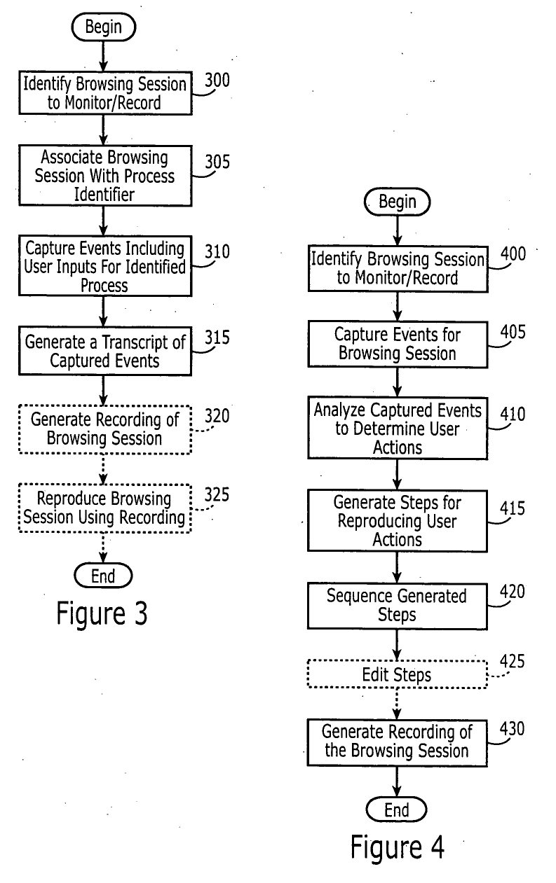

Operations for monitoring and/or recording a browsing session will now be described for some embodiments of the present invention with reference to the flowchart illustrations of FIGS. 3-9. Dotted lines in various of the figures may indicate optional operations according to some embodiments of the present invention. Referring first to the flowchart illustration of the embodiments of FIG. 3, operations begin at block 300 by identifying a browsing session to be monitored. For the embodiments illustrated in FIG. 3, the browsing session is associated with a process identifier of the operating system of a computer executing the browsing session (block 305).

Events associated with the identified browsing session are captured (block 310). In particular, for the embodiments illustrated in FIG. 3, capturing of events at block 310 may include capturing user input received through one or more tasks executing on the operating system having the associated process identifier, with at least one of the tasks not being a browser task instance. In other words, in addition to obtaining user input during monitoring and recording related to web browser user interactions through a monitored browser application, the illustrated embodiments of FIG. 3 can support obtaining user input related to a browsing session through applications other than browser instances, such as dialog boxes generated by the operating system during the course of a browsing session being monitored.

A transcript of the captured events is generated (block 315). As will be described further herein, the transcript generated at block 315 may have a variety of levels of detail specified for the transcript, which levels of detail result in various degrees of filtering of the captured events included in the generated transcript. In addition to generating a transcript of captured events, a recording of the browsing session may be generated based on the captured events (block 320). The browsing session may then be reproduced by playing back the recording (block 325).

Further embodiments of methods for monitoring a browsing session executing on a computer system will now be described with reference to the flowchart illustration of FIG. 4. For the embodiments illustrated in FIG. 4, operations begin at block 400 by identifying a browsing session to be monitored. Events associated with the identified browsing session are captured (block 405). The captured events are analyzed to determine corresponding user actions associated with the browsing session (block 410). Steps for reproducing the corresponding user actions are generated based on the captured events (block 415). Operations at block 415 may include identifying a frame associated with at least one of the steps and identifying a nesting relationship of the identified frame with other frames associated with the browsing session in the embodiments illustrated in FIG. 4.

In some embodiments of the present invention, operations related to generating steps at block 415 may include identifying a user input associated with one of the steps, where the user input includes a user designation of a position on a web page or a window associated with the browsing session and/or text input thereto. The generating operations at block 415 may further include identifying an attribute of an element associated with the user input. For example, the element may be an HTML element and the attribute may be a URL address for the HTML element. A plurality of attributes of the element associated with the user input may be identified for some elements. The window associated with the user input may also be identified.

Generated steps are sequenced based on a sequence of occurrence of the corresponding user actions during the browsing session (block 420). In some embodiments, the steps may be edited (block 425) before generating a recording of the browsing session based on the sequenced steps (block 430).

A variety of different operations may be utilized for editing generated steps at block 425. In some embodiments of the present invention, a delay step may be inserted between selected ones of the sequenced steps, where the delay step may be configured to delay transition between the selected ones of the sequenced steps on playback of the recording. Such inserted delay steps may, for example, provide for a delay time to compensate for variations in content server response time during playback relative to recording or to account for delay periods between the user inputs during the recording session. In some embodiments of the present invention, operations associated with editing at block 425 may include editing one or more of the generated steps to define a completed condition for the step. For example, a page complete message may be sent as part of the communication protocol for the browsing session to indicate completion of downloading of an HTML page so that operations may continue to allow a next user input to be recreated after the previously requested HTML page is in place. Such user of a completed condition criteria for a step may be used in combination with or as an alternative to inserting delays between steps to ensure proper operation during playback of a browsing session.

In some embodiments of the present invention, the completed condition is defined as the receipt of a download complete signal. A selected delay time after receipt of the download complete signal may also be specified. A selected delay time after a page change associated with an edited one of the generated steps may also be used as a completed condition and/or an estimate of a completed condition based on signals other than a download complete signal received by a browser associated with the browsing session. Thus, a variety of different conditions for detecting completion, or delaying to allow completion, before moving to a next step on playback may be selected at block 425 to increase the likelihood of successful playback of the recorded browsing session. As a further approach to increase the likelihood of successful playback, before playing a recording to reproduce a browsing session, a playback speed of the recording may be selected, where the playback speed defines a delay between completion of each step and a beginning of the next step as contrasted with inserted delays specific to a transition between two particular steps.

In further embodiments of the present invention, operations at block 425 include determining one of a plurality of attributes of an element associated with a user input that is expected to remain unchanged for playback of the recording. The one of the plurality of attributes of the element that is expected to remain unchanged may be selected for use in locating the element on playback of the recording. Thus, in addition to allowing for response time and other timing and delay related issues on recreation of a browsing session, the dynamic nature of the content that may be retrieved over the Internet during a browsing session may be compensated for by appropriate selection of an attribute used for retrieval of such content during the playback of the recorded session at different times in the future. Such selection of an attribute may reduce the number of playback errors associated with finding particular content, which otherwise might create an error, such as a page not available error condition due to a changed state or location of the requested content during playback of the recorded browsing session.

In some embodiments of the present invention, a unique identifier may be generated and assigned as one of the attributes of an element associated with a user input detected while capturing events at block 405. The unique identifier may correspond to a relative position of the element when user input was received. It may be determined that all of the attributes of the element associated with the user input, other than the unique identifier, are not expected to remain unchanged for playback of the recording. In such circumstances, the unique identifier may be selected for use in locating the element on playback of the recording in some embodiments of the present invention.

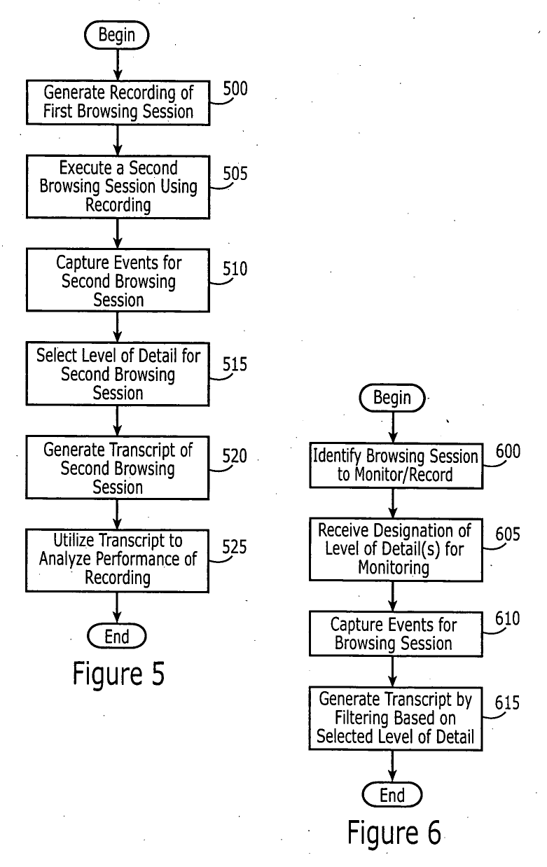

Other embodiments of the present invention will now be described with reference to the flowchart illustration of FIG. 5. For the embodiments illustrated in FIG. 5, operations begin at block 500 by generating a recording of a first browsing session, for example, as described for various of the embodiments of the present invention described with reference to FIG. 3 or FIG. 4. A second browsing session is executed using the recording (block 505). Events associated with the second browsing session are captured, including capturing user input associated therewith (block 510). A level of detail for a transcript of the second browsing session is selected (block 515). The level of detail designates one of a plurality of categories of events associated with a browsing session that may be captured. A transcript of the second browsing session is generated by filtering the captured events associated with the second browsing session based on the determined level of detail (block 520). The generated transcript has a level of detail greater than the recording used to execute the second browsing session. The transcript is utilized to analyze the performance of the recording (block 525).

The level of detail selection operations at block 515 may include changing the level of detail while capturing events during the second browsing session. As such, the level of detail included in the transcript may be changed during monitoring of the second browsing session. In further embodiments of the present invention, the level of detail for a transcript may be selected for a number of different browsing sessions, where a subsequent browsing session has a level of detail for a transcript selected that is different from the level of detail for the transcript of the second browsing session. Operations for analyzing the performance of the recording using the transcript at block 525 may include editing at least one of the generated steps, where the editing includes reviewing the transcript of the captured events to determine what to edit.

Further embodiments of methods for monitoring a browsing session executing on a computer system will now be described with reference to the flowchart illustration of FIG. 6. For the embodiments illustrated in FIG. 6, operations begin with identifying a browsing session to be monitored and/or recorded (block 600). A designation of one of a plurality of levels of detail for a transcript of the browsing session is received (block 605). The plurality of levels of detail designate different ones of a plurality of categories of events associated with a browsing session that may be captured. Events associated with the identified browsing session are captured, including capturing user input (block 610). The transcript of the browsing session is generated by filtering the captured events associated with the browsing session based on a selected one of the plurality of levels of detail (block 615). A second selection of a different one of the plurality of levels of detail may be received while capturing events in some embodiments of the present invention. Furthermore, another browsing session to be monitored may be identified and a level of detail for a transcript of the new browsing session may be selected that is different from the one for the previous session.

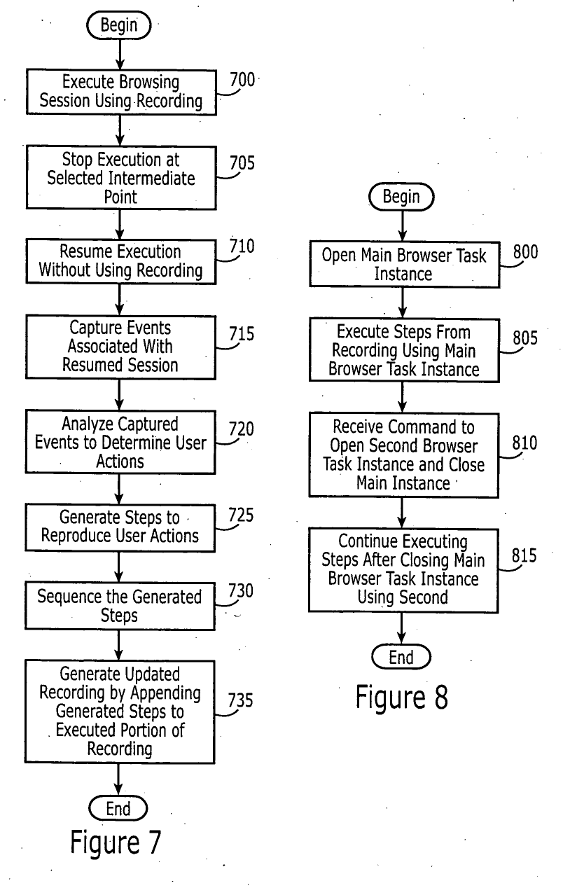

Further embodiments of the present invention will now be described with reference to the flowchart illustration of FIG. 7. As shown in FIG. 7, operations begin by executing a browsing session using a recording including a plurality of sequenced steps for reproducing user actions (block 700). Execution of the browsing session is stopped at a selected intermediate step of the recording (block 705). Execution of the browsing session is resumed without use of the recording including accepting new user input (block 710). Events associated with the resumed browsing session are captured, including capturing additional user input (block 715).

The captured events are analyzed to determine corresponding user actions associated with the resumed browsing session (block 720). Steps for reproducing the corresponding user actions are generated based on the captured events (block 725) and the generated steps are sequenced based on a sequence of occurrence of the corresponding user actions during the resumed browsing session (block 730). An updated recording is generated by appending the generated sequence steps to ones of the plurality of sequence steps for reproducing user actions preceding the selected intermediate step (block 735). In other words, the steps generated based on operations by a user during the resumed session are appended to the executed portion of the recording before the resumed session is initiated to capture new user input to provide an updated recording.

Methods for reproducing a recorded browsing session on a computer system according to some embodiments will now be described with reference to the flowchart illustration of FIG. 8. A main browser task instance for the browsing session is opened (block 800). Steps for reproducing user actions included in a recording of a recorded browsing session are sequentially executed using the main browser task instance (block 805). A command is received to open a second browser task instance for the browsing session as well as a command to close the main browser task responsive to execution of one or more of the steps of the recording (block 810). Operations related to sequentially executing steps in the recording continue using the second browser task instance after closing the main browser task instance (block 815). The operations described with reference to blocks 805-815 may be carried out by a thread of code running independently of the main browser task instance and the second browser task instance.

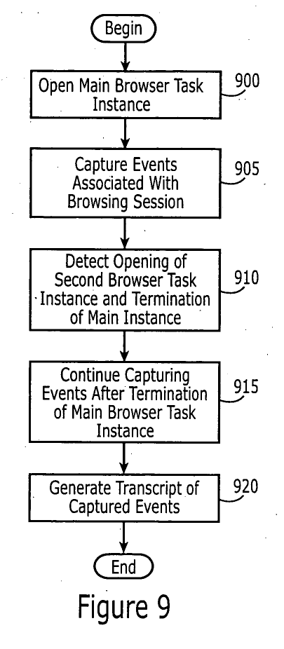

Further embodiments of the present invention for monitoring a browsing session executing on a computer system will now be described with reference to the flowchart illustration of FIG. 9. As shown in the embodiments of FIG. 9, a main browser task instance for a browsing session to be monitored is opened (block 900). Events associated with the identified browsing session are captured (block 905). Opening of a second browser task instance for the browsing session is detected (block 910). Events associated with the identified browsing session continue to be captured after termination of the main browser task instance (block 915). A transcript is generated of the captured events (block 920). Operations at block 900-920 may be carried out by a thread of code running independently of the main browser task instance and the second browser task instance.

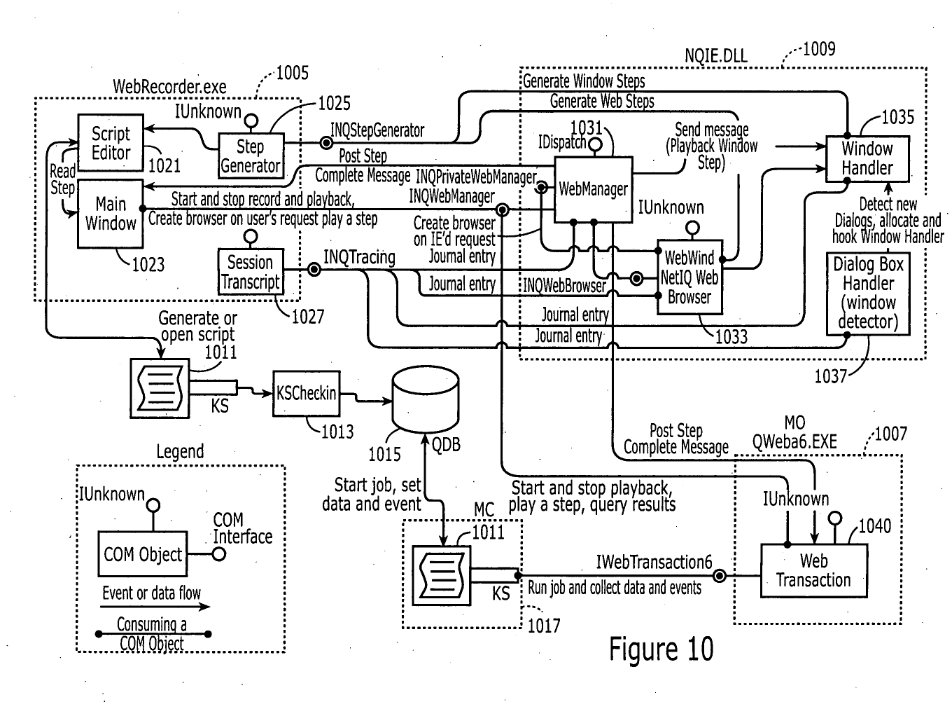

An architecture for a web recorder/player according to some embodiments of the present invention will now be further described. For purposes of illustration, this description will be presented with reference to a Windows based implementation utilizing dynamic linked library code (.dll) for various aspects of the web recorder and/or player. More particularly, the architecture and operations described with reference to FIGS. 10-17 are presented with reference to a NetIQ managed object (MO) and recorder application available as part of the Application Manager Suite available from NetIQ Corporation of San Jose, Calif. As illustrated in the schematic block diagram of FIG. 10, the .dll code NQIE.dll 1009 may be used by both the recorder WebRecorder.exe 1005 and other players, such as the code Qweba6.exe 1007 designated as the MO in FIG. 10. As such, common code may be used for both recording and playback by the recorder 1005 and live by the MO 1007.

The recorder WebRecorder.exe 1005 may be the launcher code and may generate the session transcript view, an options dialog box and file manipulation functions. As shown in FIG. 10, the recorder 1005 includes a launcher, the Main Window 1023, the session transcript view 1027, a script editor 1021, a step generator 1025, the options dialog box and file manipulation functions. On startup, the recorder 1005 may read a variety of properties from the registry, and call WebManager::put_Properties to assign those values to a WebManager 1031 portion of NQIE.dll 1009. Most of these values may also be set by a user using the options dialog box. The options dialog box may expose all possible options or a portion thereof. When ever any of these options are changed, the recorder 1005 may call WebManager::put_Properties to apply them.

The Session Transcript view 1027 may be a COM object that implements an INQTracing interface defined in NQIE.DLL 1009. It may be a window running on a separate thread. When a separate thread calls for Session Transcript, the new text may be concatenated on a buffer. A timer may dump the buffer to the display periodically. As such, when a Session Transcript method is called, it need not be slowed by any screen display function.

The Recorder 1005 allocates that window when created, and may then connect it to the WebManager 1031 to support tracing of actions by a browser, identified as WebWnd NetIQ Web Browser 1033 in FIG. 10. The MO player 1007 illustrated in FIG. 10 does not provide any Session Transcript window and may, therefore, not provide session transcription during playing of a recorded session script.

The Step Generator 1025 may be supplied through a user interface of the Web Recorder 1005 and may be invoked by components actively involved in the recording process of user actions. The Step Generator 1025 may be configured to directly inject a new step in the Script Editor 1021 as needed during recording of a session. Each method of the INQStepGenerator interface may represent a type of step and a well defined dedicated structure may be passed as single argument. Each step may be existing in the Script Editor 1021 as a created function from the INQStepGenerator interface during recording, although a delay step may be provided that may be inserted directly in the Script Editor 1021 User Interface by a user rather than by any component actively involved in the recording process. Step generator 1025 code may include the following:

interface INQStepGenerator : IUnknown{

// GENART is one of the CSG classes or SG structures
// declared on the Generator Structures section
// of wr3def.h
[id(1)] HRESULT NewBrowserOnUserRequest( );
[id(2)] HRESULT OpenInNewWindow(BSTR URL);
[id(3)] HRESULT CloseWindowOnUserRequest(GENARG Window
/* SGWindow*

*/);

[id(4)] HRESULT Resize(GENARG Window /* SGWindow* */,
long CX, long CY);
[id(5)] HRESULT GoBack(GENARG Window /* SGWindow* */);
[id(6)] HRESULT GoForward(GENARG Window /* SGWindow*
*/);
[id(7)] HRESULT Navigate(GENARG Window /* SGWindow*
*/, BSTR URL);
[id(8)] HRESULT Click(GENARG StepInfo /* SGClickCStepInfo
*/);
[id(9)] HRESULT TextChange(GENARG StepInfo /*
SGCTextChangeStepInfo */);
[id(10] HRESULT Check(GENARG StepInfo /* CSGCheckStepInfo
*/);
[id(11)] HRESULT Select(GENARG StepInfo /* CSGSelectStepInfo
*/);
[id(12)] HRESULT Search(GENARG StepInfo /*
CSGSearchStepInfo */);
[id(13)] HRESULT AdvancedSearch(GENARG StepInfo /*
CSGStepInfo */);
[id(14)] HRESULT WinClick(GENARG StepInfo /*
CSGWinClickStepInfo */);
[id(15)] HRESULT WinTextChange(GENARG StepInfo

/* CSGWinTextChangeStepInfo */);

[id(16)] HRESULT WinCheck(GENARG StepInfo /*
CSGWinCheckStepInfo */);
[id(17)] HRESULT WinSelect(GENARG StepInfo /*
CSGWinSelectStepInfo */);

}

Registry values used by the recorder 1005 may include the following:

| | | |
|---|---|---|
| Name | Type | Value and description |

[HKEY_CURRENT_USER\Software\NetIQ\Response Time\Web Recorder]

| | | |
|---|---|---|
| XTRACING | REG_DWORD | Horizontal upper left corner coordinate of |
| | | the Session Transcript view |
| YTRACING | REG_DWORD | Vertical Upper left corner coordinate of |
| | | the Session Transcript view |
| CXRTRACING | REG_DWORD | Width of the Session Transcript view |
| CYRTRACING | REG_DWORD | Height of the Session Transcript view |
| Tracing Visible | REG_DWORD | (0, 1) Default 1, Show Session Transcript |
| | | view on startup |
| Frames And Forms Structure | REG_DWORD | (0, 1) Default 0; Display only the frame |
| | | and the forms on the HTML Structure. |

[HKEY_CURRENT_USER\Software\NetIQ\Response Time\Web Recorder\Options]

| | | |
|---|---|---|
| Ignore Mouse Over Window | REG_DWORD | (0, 1) Default 0, |
| Ignore Mouse Over HTML | REG_DWORD | (0, 1) Default 0, |
| Objects | | |
| Session Transcript Level | REG_DWORD | (0, 1, 2, 3, 4) Default 0, |
| Force Document Complete | REG_SZ | (5.0-3600.0) Default 5, seconds. |
| after Navigate | | |
| Force Document Complete | REG_SZ | (0.5-10) Default 0.5, seconds |
| after Download Complete | | |
| Ignore Mouse Down | REG_DWORD | |
| Ignore Focus In | REG_DWORD | |
| Ignore Focus Out | REG_DWORD | |

The common module (NQIE.dll) 1009 may include code that implements the Browser 1033, an HTML Structure View, and Navigation, Recording and Playback features. Both the Recorder 1005 and the MO 1007 use this module 1009 for recording and/or playback. It may implement Web and Windows sniffing and Session Transcript capabilities as well as the logic to record and playback a Web Transaction script 1011. This module may also be the only one to manipulate and understand the transaction part of the script. The recorder 1005 and the MO 1007 may simply pass the needed information to the Web Manager 1031.

The core NQIE.dll 1009 may include, the WebManager object 1031 providing the connection with the recorder 1005 and/or the MO 1007, the WebBrowser object 1033 providing the actual browser instance(s), the HTML Structure View, the Object Properties View, a Web Event handler (which may be integrated in the WebWnd Web Browser) and Windows 1035 and Dialogbox 1037 handlers.

The Web Manager 1031 may be the only COM object that can be used from an external consumer. The Manager 1031 may be responsible to set the environment via the “Properties” property as well as create browsers 1033 on demand. It may implement two interfaces and the following respective supported methods and properties:

INQWebManager: Connection with the outside world.
INQPrivateWebManager: For internal use only.
INQWebManager Supported methods

| Method | Description |
|---|---|
| CreateNewBrowser | Creates a new browser specifically requested by the user. |
| CloseAllBrowsers | Close all browsers when the recorder is shutting down. |
| PopupWindow | “not used” |
| StartRecording | Initialize the environment for a new recording session, |
| | closes all windows and reset window index to 1 |
| StopRecording | Stop the recording mode |
| InitPlayback | Initialize the environment for playback |
| PlayStep | Play a step. The step information is the argument of the call |
| StopPlaying | Stop the playback mode |

INQWebManager Supported properties Those properties can set or get using the
Properties property with and a name/valye pair

| | | |
|---|---|---|
| Property | VARIANT Type | Description |

Properties are declared on wr3def.h file

| ParentWindow | VT_BYREF\|VT_INT | Windows using the WebManager. |
|---|---|---|
| | (HWND) | All message or dialog box would |
| | | have this window as parent. |
| TracingObject | VT_UNKNOWN | Pointer to an object implementing |
| | (IUnknown*) | INQTracing for Session Transcript |
| | | capability. |
| Force Document | VT_R8 | See section Error! Reference source |
| Complete after Navigate | (double) | not found. Option dialog box |
| Force Document | VT_R8 | See section Error! Reference source |
| Complete after | (double) | not found. Option dialog box |
| Download Complete | | |
| EnterpriseEdition | VT_I4 | Not used yet |
| | (BOOL) | |
| Ignore Mouse Over | VT_I4 | See section Error! Reference source |
| HTML Objects | (BOOL) | not found. Option dialog box |
| Ignore Mouse Over | VT_I4 | See section Error! Reference source |
| Window | (BOOL) | not found. Option dialog box |
| Tracing Level | VT_I4 | See section Error! Reference source |
| | (enum) | not found. Option dialog box |
| Frames And Forms | VT_I4 | See section Error! Reference source |
| Structure | (BOOL) | not found. HTML Structure View |
| | | Interaction |
| Ignore Mouse Down | VT_I4 | See section Error! Reference source |
| | (BOOL) | not found. Option dialog box |
| Ignore Focus In | VT_I4 | See section Error! Reference source |
| | (BOOL) | not found. Option dialog box |
| Ignore Focus Out | VT_I4 | See section Error! Reference source |
| | (BOOL) | not found. Option dialog box |

| | | |
|---|---|---|
| Address Bar Entry | VT_BSTR | New address bar entry |

(BSTR)

| | |
|---|---|
| Help file path | VT_BSTR |

| | (BSTR) | |
|---|---|---|
| Silent mode | VT_I4 | Used by the managed object |

| | (BOOL) |
|---|---|
| Path to save the session | VT_BSTR |
| transcript | (BSTR) |
| Log Session Transcript | VT_I4 |
| | (BOOL) |
| Log Path | VT_BSTR |
| | (BSTR) |
| Assert Path | VT_BSTR |
| | (BSTR) |
| Trace | VT_I4 |
| | (BOOL) |

Standard COM properties

| StepTime | [in] BSTR Name, | (read only) Get the specific step time |
|---|---|---|
| | [out, retval] | on playback |
| | VARIANT* pVal | |
| StepErrorCode | [in] long Step, [in] | (read only) Get a specific step error |
| | long Occurence, | code. Occurrence is the error index for |
| | [out, retval] long | specific step. |
| | *pVal | |
| StepErrorDescription | [in] long Step, [in] | (read only) Get a specific step error |
| | long Occurence, | description. Occurrence is the error |
| | [out, retval] BSTR | index for specific step. |
| | *pVal | |

| | |
|---|---|
| Method | Description |

INQPrivateWebManager Supported methods

| | |
|---|---|
| CreateNewBrowserOnIERequest | Creates a new browser specifically requested |
| | by IE. |
| OpenInNewWindow | Navigate a specific URL in a new browser |
| AddNewAddress | Add a new URL to the list of address |
| PostStepComplete | After a window step is considered complete, |
| | the WebBrowser calls this function. This |
| | function post a message to a window or a |
| | thread specified in the InitPlayback method. |
| IncrementSteptime | Increment the value of the time measured for |
| | a specific step. |
| AddStepError | Add an error code and description to a step. |
| | Several errors can be associated to a step |
| NewWinStep | Used asynchronous insertion of windows step |
| WinStepComplete | Used by default timeout for windows step playback |
| AddPlaybackError | Add an internal error which is not related to |
| | a specific step |
| MoveCursor | Move the mouse pointer to a already known coordinate |

INQPrivateWebManager Supported properties

| | |
|---|---|
| CurrentStep | (Read only) get the actual playback step index |

The Web Window (WebWnd) may be provided by the Web Browser 1033. The Web Manager 1031 may be set up as the only entity allowed to allocate and interact with the Web Browser 1033. The INQWebBrowser interface may be implemented as follows by the Web Browser 1033:

INQWebBrowser Supported methods

| Method | Description |
|---|---|
| ResetTime | Reset download time |
| CreateBrowser | Allocate the browser |
| Navigate | Navigate a specific URL |
| Close | Close the browser |
| Resize | Resize the browser |
| GoBack | Go back command of IE |
| GoForward | Go forward command of IE |
| ExecuteClickStep | Click on an element |
| ExecuteTextChangeStep | Set text on an input element |
| ExecuteCheckStep | Set check state to a check box or a |
| | radio button |
| ExecuteSelectStep | Set the selection of a select element |
| | (list box) |
| ExecuteSearchStep | Invokes the IE FindText function on |
| | a specified browser and frame |
| ExecuteAdvencedSearchStep | Look for the existence of a specific |
| | element on a specific browser, frame |
| | and/or form |
| EnsureObjectVisible | Scrolls the specific browser and frame |
| | to make the specified object is entirely |
| | visible . . . if possible |

INQ WebBrowser properties

| Property | Type | Description |
|---|---|---|
| WebWindowIndex | Long | Get/Set the browser |
| | | window index |
| WebWindowTitle | BSTR | (read only) Get the |
| | | browser window title |
| Broker | INQPrivateWebManager* | Get/Set the a hook to |
| | | the Web Manager |
| WindowList | INQWebBrowser* list | Get/Set a list of |
| | | browser windows |
| Browser | IUnknown* | (read only) Get a hook |
| | | on the Internet |
| | | Explorer control |
| HWND | HWND | (read only) Get the |
| | | handle of the |
| | | Browser window |
| IECtrl | HWND | (read only) Get the |
| | | handle of the |
| | | Internet Explorer |
| | | control window |
| StepIndex | Long | Get/Set the step |
| | | index |

The MO QwebA6.exe 1007 may provide a background playback engine (i.e., play back recorded scripts). This engine may not only playback in background but also may manage both the access and the life of the real playback code located in NQIE.dll 1009. The MO module 1007 may implement one COM object WebTransaction 1040 that may be the entry point from the recorded script 1011 that is played back.

As the NetIQ Web Browser 1033 in some embodiments uses Microsoft Internet Explorer, which uses WinINet, the playback MO 1007 may also operate to manage and limit internet resource access.

The NQWeb Transaction module 1040 may be a COM object that is the entry point for the playback script 1011. It may provide all functionalities to configure the engine, run the transaction and extract individual data points and events during playback. It may use a limited number of methods and one universal “Properties” property. Except for the script (such as a Vbscript) that is played back, in and out parameters may be set using a property; including all data points and events. Associated methods, properties etc. in some embodiments include the following:

Supported methods

| Method | Description |
|---|---|
| ExecuteTransaction | Creates a new browser specifically |
| | requested by the user. |
| AddStepInfo | Set all individual step settings |
| | exposed from the script |

INQWebManager Supported properties

| Property | VARIANT Type | Description |
|---|---|---|
| Script | VT_BSTR | Base 64 encoded part |
| | | of the knowledge |
| | | script. It is the |
| | | content of an file |
| | | saved as an XML |
| DataPoints | VT_DISPATCH | All possible data |
| | (PropertySet) | point |
| Events | VT_DISPATCH | All possible events |
| | (PropertySet) | |
| JobTimeout | R/W VT_I4 | Job Timeout |
| JobTimeoutEventSeverity | R/W VT_I4 | Job Timeout Event |
| | | Severity |
| StepFailureEvent | R/W VT_BOOL | Event when a |
| | | transaction step |
| | | fails |
| StepFailureEventSeverity | R/W VT_I4 | Event severity when |
| | | a transaction step |
| | | fails |
| ResponseTimeThreshold | R/W VT_I4 | Response time |
| | | threshold (seconds) |
| ThresholdEvent | R/W VT_BOOL | Event when the |
| | | Threshold is |
| | | exceeded |
| ThresholdEventSeverity | VT_I4 | Event Severity when |
| | | the Threshold is |
| | | exceeded |
| ShowDetailBreakdown | R/W VT_BOOL | Show response time |
| | | breakdown, in many |
| | | scenarios it's |
| | | not accurate. |
| | | Hidden, default |
| | | FALSE. |
| JobId | R/W VT_I4 | Job ID |
| CollectData | R/W VT_BOOL | Collect overall |
| | | response time and |
| | | availability data |
| DataDetail | R/W VT_BOOL | Store extended |
| | | information with |
| | | data points |
| IndividualStepData | R/W VT_BOOL | Collect response |
| | | time data for |
| | | individual steps |
| ScriptVersion | R/W BSTR | To pass to the MO, |
| | | so the MO can |
| | | verify the version |
| | | of the script. |
| Version | RO VT_BSTR | Version of the MO. |
| | | Compared in the KS |
| | | with MIN_MO_VERSION. |
| SaveResults | R/W VT_BOOL | |
| SaveResultsPath | R/W VT_BSTR | |
| | R/W VT_BSTR | |

In some embodiments of the present invention, operations on playback are based on Job timeout and Step timeout. Those two values may be set by the playback script. The number of jobs having access to Internet Resources for playback on a given computer may be limited to reduce the risk of playback failure due to resource utilization/availability problems.

When an element specified in a web session being recorded has nothing unique to be used for retrieval during playback, even the display string, it may be necessary to dig up until the element is retrieved, rather than rely on an HREF or a SRC.

For example, a text decoration element as FONT of B can catch a click, but this element doesn't generally have any NAME or ID and the display text might be duplicated somewhere else, so the only way to retrieve this element may be by moving up until we find an A element. The A element may then have an HREF that CAN be used for retrieval. Exemplary related attributes include the following:

| | | Undercover |
|---|---|---|
| Attribute | Interactive Elements | elements |
| HREF | A, AREA, LINK | BASE |
| SRC | APPLET, EMBED, FRAME, IFRAME, | |
| | IMG, INPUT type=image, XML | |
| ID | ALL | |
| NAME | A, APPLET, attribute, BUTTON, | |
| | EMBED, FORM, IMG, INPUT | |
| | type=button, INPUT type=checkbox, | |
| | INPUT type=file, INPUT type=hidden, | |
| | INPUT type=image, INPUT | |
| | type=password, INPUT type=radio, | |
| | INPUT type=reset, INPUT type=submit, | |
| | INPUT type=text, LINK, MAP, | |
| | OBJECT, RT, RUBY, SELECT, | |
| | TEXTAREA, FRAME, FRAMESET, | |
| | IFRAME | |
| VALUE | BUTTON, INPUT, INPUT | |
| | type=checkbox, INPUT type=hidden, | |
| | INPUT type=button, INPUT type=radio, | |
| | INPUT type=reset, INPUT type=submit, | |
| | INPUT type=password, INPUT | |
| | type=text, OPTION, SELECT, | |
| | TEXTAREA | |
| OnClick | A, ADDRESS, APPLET, AREA, B, | |
| | BDO, BIG, BLOCKQUOTE, BODY, | |
| | BUTTON, CAPTION, CENTER, CITE, | |
| | CODE, CUSTOM, DD, DFN, DIR, | |
| | DIV, DL, document, DT, EM, EMBED, | |
| | FIELDSET, FONT, FORM, hn, HR, I, | |
| | IMG, INPUT type=button, INPUT | |
| | type=checkbox, INPUT type=file, | |
| | INPUT type=image, INPUT | |
| | type=password, INPUT type=radio, | |
| | INPUT type=reset, INPUT type=submit, | |
| | INPUT type=text, KBD, LABEL, | |
| | LEGEND, LI, LISTING, MAP, | |
| | MARQUEE, MENU, nextID, NOBR, | |
| | OBJECT, OL, P, PLAINTEXT, PRE, | |
| | RT, RUBY, S, SAMP, SELECT, | |
| | SMALL, SPAN, STRIKE, STRONG, | |
| | SUB, SUP, TABLE, TBODY, TD, | |
| | TEXTAREA, TFOOT, TH, THEAD, | |
| | TR, TT, U, UL, VAR, XMP | |

The WebRecorder.EXE 1005 may generate a script 1011 from a recorded web session using a template. The steps determination of the particular script may be generated by a WebManager::Script property. This string property may be filled by the Web Recorder 1005 (open file) or by the MO 1007, or may be generated by the WebManager 1031 during the recording session. During the script generation, the Recorder 1005 may merge this string into the script 1011 generated from the template. During playback, the Recorder 1005 or the MO 1007 may extract this part of the script and set WebManager::Script property with it. Then, from this point, they may only have to call WebManager::Play. The part of the script that will be passed to the MO 1007 may be Base 64 encoded. The encoding and decoding may use the ATL Server 7.1 Base 64 functions.

The script 1011 may be tagged with a Script Version and a MIN_MO_VERSION. This may be used for later player version compatibility issues. If the MIN_MO_VERSION is higher than the MO version, an error may be generated. The Script Version may be passed to the MO 1007, if the Script Version is lower than the supported script version by the MO 1007, some feature might be cut, or the MO 1007 may reject the script 1011. The script generation may use a QML file.

The web recorder 1005 may be a multi-threaded application. A thread in the Microsoft Window Operating System is a piece of code executing in a process. All the related threads may be running simultaneously, so it seems like each one of them owns the entire CPU. Threads were first available in Windows NT. The recorder User interface may run in it's own thread, the Web Manager 1031 and the browser(s) 1033 may be running in another thread and the session transcript 1027 may be running in it's own thread, and Response Time tracing(s) may be running in their own thread (tracing response times during playback). The Dialogbox Handler 1037 that detects new dialog boxes may also run in its own thread.

As a result, an application with a user interface that is extremely fluid may be provided. If this application is not built this way, it may seem to a user to be frozen often. The Internet Explorer Control may still be slowed down once in a while. In reality, these slowdowns may not be in the IE Control itself, but rather the internet traffic contention combined with network security may cause delays.

The WebRecorder.exe module 1005 may include the Main Window 1023, which may host the Script Editor 1021 and the Session Transcript window 1027. The Main Window 1023 may own one instance of the Script Editor 1021, one instance of the Step Generator 1025 and one instance or the Session Transcript 1027. The Session Transcript 1027 may run in its own thread, so whenever a component writes a Journal Entry, the Session Transcript 1027 may simply write the new string in a buffer, so the object calling is not slowed down by the process of refreshing the Session Transcript Window.

When the WebRecorder.exe 1005 program starts, it may allocate the WebManager 1031 on a new thread. Only one WebManager 1031 instance can be allocated by a process in some embodiments. Whenever the Web Manager 1031 is allocated, a Dialogbox Handler 1037 may also be allocated on its own thread. Then the Main Window 1023 may pass a Session Transcript 1027 reference to the WebManager 1031 using the “Tracing Object” property. The WebManager 1031 may make the Session Transcript 1027 reference available to the Dialogbox Handler 1037 and each instance of WebWnd 1033 and Window Handler 1035 so each of them can start calling methods on INQTracing like INQTracing::AddText or INQTracing::AddLine.

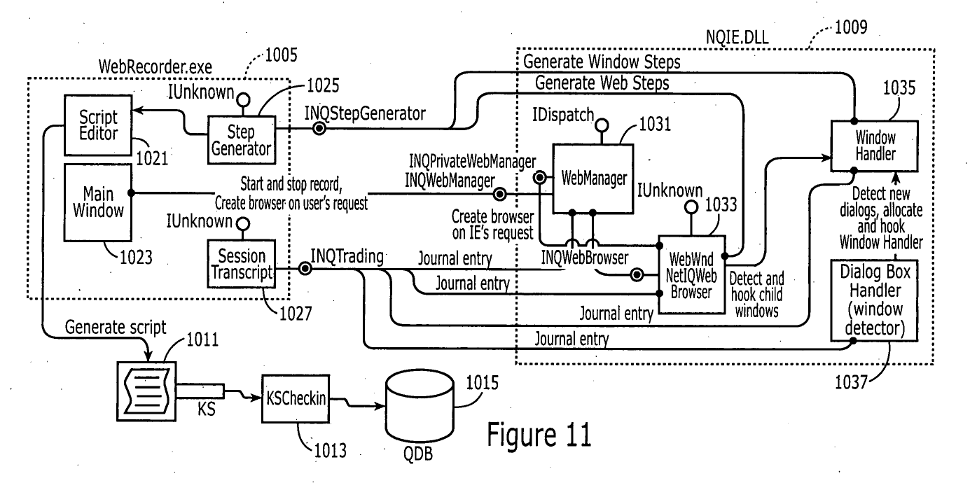

The Web Manager 1031 in some embodiments supports three modes, Browsing (default), Recording and Playback as will be described with reference to FIGS. 11-17. The behavior of each NQIE component in some embodiments will be different in each situation.

Referring now to the exemplary embodiments of FIGS. 11-13, when a user starts the recording, the Main Window 1023 first calls INQWebManager::CloseAllBrowsers method to clear the desktop. Then it calls INQWebManager::StartRecording to initialize the recording environment. This method uses two arguments, one of them is a reference to the StepGenerator 1025 and the other one is a reset flag to reset the Browser Index to zero if necessary.

The first action recorded for the web session is the creation of a new browser. The user clicks on new browser on the Main Window, which invokes INQWebManager::CreateNewBrowser method. This method allocates a new WebWnd instance 1033 and calls INQWebBrowser::CreateBrowser method with the (User's request) flag. INQWebBrowser::CreateBrowser allocates the physical browser display and invokes INQStepGenerator::NewBrowserOnUsersRequest in order to generate the new step. The new step called “New Browser on Users Request” is then created.

At this point, the user usually interacts directly with the Browser window 1033 and any nested windows and/or dialog boxes to generate new steps. When the user does some actions on the browser interface of the WebWnd 1033, the WebWnd 1033 invokes the Step Generator 1025 directly to generate new steps.

When a web page is refreshed, the WebWnd browser 1033 is looking for any ActiveX control or Java applets, which require a dedicated Window. If it finds any, WebWnd 1033 allocates a new Window Handler 1035 for each. While the Dialogbox Handler 1037 is spinning in background, if any dialog is showing up, it will also allocate a Window Handler 1035 for the dialog and each children in the window's hierarchy. When the user does an action on a window hooked by a Window Handler, Window Handler 1035 will invoke the Step Generator 1025 directly to generate a Window step.

Sometime, a web page will try to spawn another one. Very often the goal is to show an advertisement, but some web applications use this feature for other reasons. When it happens, the browser that triggers the action will be queried for a new browser window (this mechanism can be used for popup blocking as well). When this happens, WebWnd 1033 invokes INQPrivateWebManager::CreateNewBrowserOnIERequest, which will allocate another WebWnd 1033 and invoke INQWebBrowser::CreateBrowser with the IE request flag, and send back a reference to of that new WebWnd to the caller WebWnd. That window can be returned to IE, which will use it to navigate a new URL. This scenario does not generate any step. INQPrivateWebManager is a WebManager 1031 interface available only for internal NQIE.DLL components use. WebManager consumers like WebRecorder.exe 1005 and QWebA6.EXE 1007 don't have access on that interface.

When the user stops the recording session, the Main Window 1023 invokes INQWebManager::StopRecording. This method will release all reference to the Step Generator on NQIE.DLL side and set the mode to browsing.

It will be understood that, while a particular sequence of operations and allocation of tasks was described above for illustrative purposes, the present invention is not limited to these particular operations or allocation of tasks or the particular illustrated number or relationship of tasks.

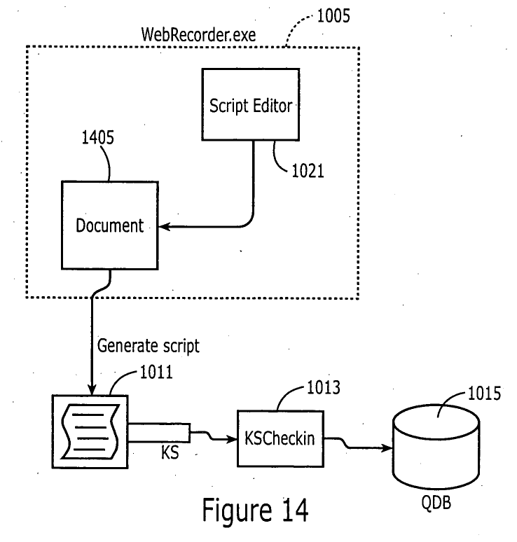

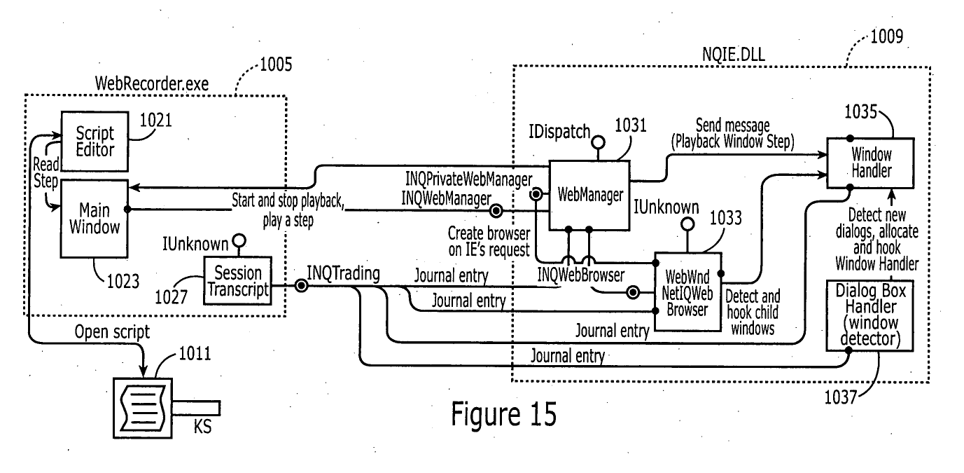

When a recording session is over, the user can save the recorded web session document 1405, for example, as an XML, a QML file 1011 or the like. It can also check-in 1013 the QML file 1011 directly into a database 1015 for future use by the MO 1007 or the like. Such operations are illustrated in FIG. 14. An exemplary playback operation according to some embodiments of the present invention will now be described with reference to FIG. 15. As with FIGS. 11-14, the particulars of this description are for illustrative purposes and not limiting of the present invention.

Playback can be initiated after a recording session, for example, in order to test the new recorded script. A previously recorded script can also be simply opened. Either way, the information then resides in the Script Editor 1021. There are two forms of play back that will be discussed for this illustrative example, a standard playback, where the recorder 1005 will play each step until it reaches the end of the script, or until it finds an error. It can also be a step by step playback, in which the user presses the step button to manually invoke each step individually.

When the user starts playback, the MainWindow 1023 invokes INQWebManager::InitPlayback, which passes a reference to the MainWindow 1023 as an argument in order to fire back some synchronization signals. The method also uses a reset flag, which is used to reset the browser ID to zero.

When a step is played, the MainWindow 1023 queries step information from the Script Editor 1021 and invokes INQWebManager::PlayStep method using the step information as an argument. The INQWebManager::PlayStep method identifies the nature of the step and take the appropriate action to play the step. If the step is “NewBrowserOnUsersRequest”, the WebManager 1031 allocates a new WebWnd 1033. If the step is a Web Step, the WebManager 1031 tries to figure out which browser (WebWnd) should be involved with the step. If it can identify it, it directly invokes INQWebBrowser::Execute . . . Step method. If the step is a Window Step, the WebManager tries to retrieve the appropriate window, and then sends a series of Window Messages to that window in order to recreate the step.

The Web Browser WebWnd 1033 is responsible to detect when a windows step should be considered complete. The Web Manager 1031 is responsible to detect when a Windows step is complete. Window Handler 1035 is also responsible for detecting when a Windows step is complete. For some more complexes case, for example a Windows step is set with a navigation marker, the Web Manager 1031 signals all Web Browsers 1033 that they are responsible to signal when the next step is complete. When a Web Browser 1033 detects a step complete situation, it invokes INQPrivateWebManager::PostStepComplete. The same scenario is true with Windows steps. When the Web Manager 1031 is responsible for the step complete it will invoke it's own PostStepComplete. This method posts a Windows message to the window specified by the INQWebManager::InitPlayback method.

When the Main Window 1023 receives the Step Complete signal, it considers the step as fully completed. At this point, it can query the Web Manager 1031 to find out if the step is a success or a failure. If it's a success, the Main Window 1023 marks the step with a checkmark in the Script Editor 1021 and it starts the playback of the following step if necessary. If the step is a failure, the Main Window 1023 marks the step an X in the Script Editor 1021 and immediately stops the playback.

Web Manager 1031, WebWnd 1033, Dialogbox Handler 1037 and Window Handler 1035 will generate entries in the Session transcript during the playback depending on the Session Transcript settings.

Whenever the playback reaches an end by completion or failure, the Main Window 1023 fills the results window. While doing so, it invokes INQWebManager 1031 to query each and every single error code and description associated with each step which had a chance to run. Whenever the playback reaches an end by completion or failure or when the user manually stops the playback, the Main Window 1023 invokes INQWebManager::StopPlaying method, which will release references to the Main Window 1023.

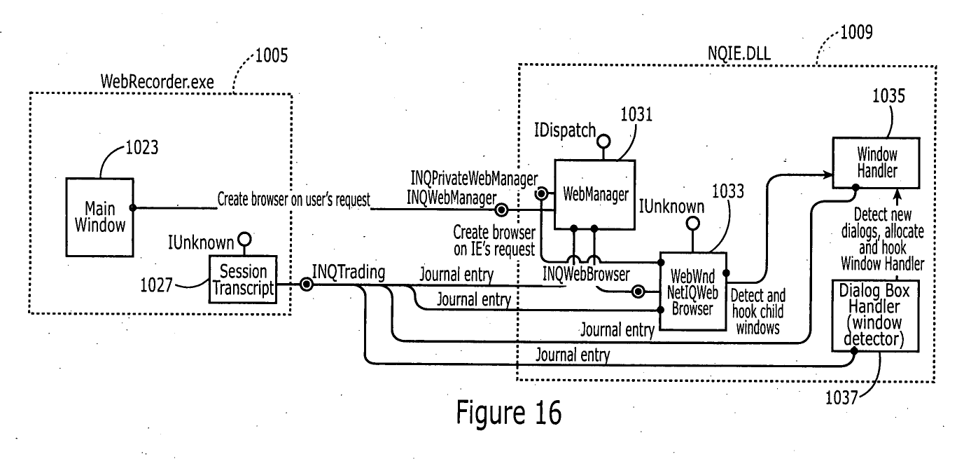

An illustrative browsing scenario according to some embodiments of the present invention will now be described with reference to FIG. 16 for illustrative purposes without limiting the present invention. During a simple browsing, no recording or playback is involved. Still the Main Window 1023 communicates with the Web Manager 1031 to allocate new instances of the Web Browser 1033. It also passes the Session Transcript 1027 reference to the Web Manager 1031 so any activity can still be written on the session transcript, as well as internal Internet Explorer activities.

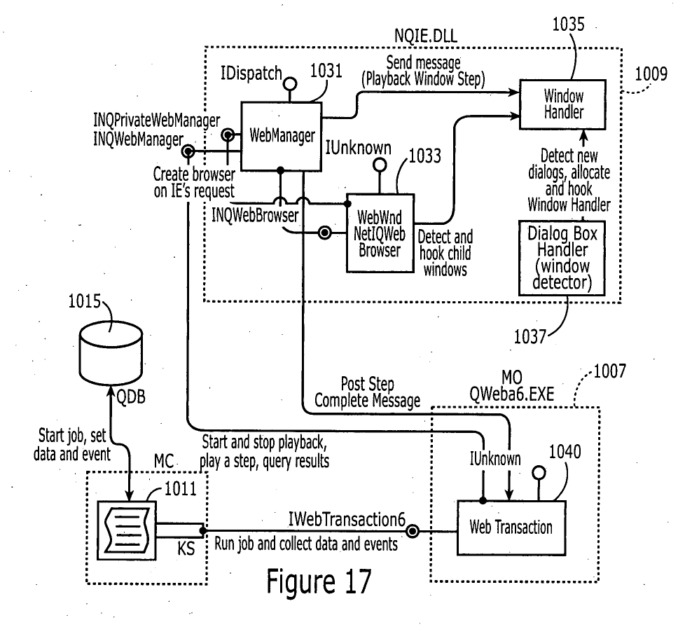

Playback in the MO 1007 according to non-limiting illustrative embodiments of the present invention is illustrated in FIG. 17. When the job starts, the script 1011 allocates Web Transaction 1040, sets all the properties and invokes the IWebTransaction6::ExecuteTransaction method. That method first allocates a new thread to run the job (job thread) and it monitors that new thread for timeout. That job thread instantiates the Web Manager 1031 and drives the playback the same way the Recorder 1005 would do it. It invokes INQWebManager::InitPlayback, which passes a reference to the job thread as an argument in order to fire back some synchronization signals. The method also uses reset flags, which are used to reset the browser ID to zero.

The job thread carries a list of steps, which it did parse from the “Script” property. It then invokes the INQWebManager::PlayStep method using the step information as argument.

The playback process is the same as with the Web Recorder 1005. When a step is complete, the Web Manager 1031 method posts a Windows message to the thread specified by the INQWebManager::InitPlayback method.

When the Web Transaction 1040 receives the Step Complete signal, it considers the step as fully completed. At this point, it can query the Web Manager 1031 to find out if the step is a success of a failure. If it's a success, the Web Transaction 1040 starts the playback on the following step if necessary. If the step is a failure, it immediately stops the playback.

Web Manager 1031, WebWnd 1033, Dialogbox Handler 1037 and Window Handler 1035 may generate entries in a log file, simulating the Session Transcript 1027. This is separate from the tracing log file.

Whenever the playback reaches an end by completion or failure the knowledge the Web Transaction 1040 invoke the StopPlaying method, which will release all references to the job thread. It will than start analyzing results and prepare data points and events with tables and so on. The Knowledge script 1011 will start to query properties on IWebTransaction6 interface to extract data points and events.

The block diagrams of FIGS. 1 through 17 illustrate the architecture, functionality, and operations of some embodiments of methods, systems, and computer program products for monitoring and/or recording a browsing session. In this regard, each block represents a module, segment, or portion of code, which comprises one or more executable instructions for implementing the specified logical function(s). It should also be noted that in other implementations, the function(s) noted in the blocks and/or process flows may occur out of the order noted in the figures.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method for monitoring a browsing session executing on a computer system having an operating system, comprising:
identifying a browsing session to be monitored;
associating the browsing session with a process identifier of the operating system;
capturing events associated with the identified browsing session, including capturing user input received through tasks executing on the operating system having the associated process identifier, wherein at least one of the tasks is not a browser task instance; and
generating a transcript of the captured events.

2. The method of claim 1, wherein generating a transcript comprises:
determining a level of detail for the transcript; and
filtering the captured events based on the determined level of detail;
wherein generating a transcript comprises generating a transcript of the filtered captured events.

3. The method of claim 1, further comprising:
analyzing the captured events to determine corresponding user actions associated with the browsing session;
generating steps for reproducing the corresponding user actions based on the captured events;
sequencing the generated steps based on a sequence of occurrence of the corresponding user actions during the browsing session; and
generating a recording of the browsing session based on the sequenced steps.

4. The method of claim 3, wherein generating steps includes identifying a frame associated with at least one of the steps and identifying a nesting relationship of the identified frame with other frames associated with the browsing session.

5. The method of claim 3, wherein generating steps includes identifying a user input associated with one of the steps, wherein the user input includes a user designation of a position on a web page or a window associated with the browsing session and/or text input thereto.

6. The method of claim 5, wherein generating steps further includes identifying an attribute of an element associated with the user input.

7. The method of claim 6, wherein generating steps further includes identifying a plurality of attributes of the element associated with the user input.

8. The method of claim 7, wherein generating steps further includes identifying the window associated with the user input.

9. The method of claim 7, wherein generating a recording is preceded by inserting a delay step between selected ones of the sequenced steps that is configured to delay transition between the selected ones of the sequenced steps on playback of the recording.

10. The method of claim 7, wherein generating a recording is preceded by editing at least one of the generated steps to define a completed condition for the step.

11. The method of claim 10, wherein the completed condition is defined as receipt of a download complete signal, a selected delay time after receipt of a download complete signal, a selected delay time after a page change associated with the at least one of the generated steps and/or an estimate of a completed condition based on signals other than a download complete signal received by a browser associated with the browsing session.

12. The method of claim 7, wherein generating a recording is preceded by selecting a playback speed of the recording, the playback speed defining a delay between completion of each step and a beginning of a next step.

13. The method of claim 7, wherein generating a recording is preceded by:
determining one of the plurality of attributes of the element associated with the user input that is expected to remain unchanged for playback of the recording; and
selecting the one of the plurality of attributes of the element that is expected to remain unchanged for use in locating the element on playback of the recording.

14. The method of claim 7, wherein generating steps further includes assigning a unique identifier as one of the attributes of the element associated with the user input, wherein the unique identifier corresponds to a relative position of the element when the user input was received.

15. The method of claim 14, wherein generating a recording is preceded by:
determining that all of the attributes of the element associated with the user input other than the unique identifier are not expected to remain unchanged for playback of the recording; and
selecting the unique identifier of the element for use in locating the element on playback of the recording when it is determined that all of the other attributes are not expected to remain unchanged.

16. The method of claim 15, wherein a frame is the element associated with the user input and wherein generating steps further includes identifying the frame associated with the user input and a nesting relationship of the identified frame with other frames associated with the browsing session as the unique identifier of the frame.

17. The method of claim 7, wherein generating a record is preceded by editing at least one of the generated steps including reviewing the transcript of the captured events to determine what to edit in the at least one of the generated steps.

18. The method of claim 3, further comprising reproducing the browsing session by playing back the recording of the browsing session.

19. The method of claim 18, wherein reproducing the browsing session includes:
terminating playing back the recording of the browsing session after a selected step of the sequenced steps to return to an intermediate state of the browsing session;
determining that subsequent events are to be captured to generate new steps for reproducing corresponding subsequent user actions;
capturing the subsequent events and generating steps for reproducing the corresponding subsequent user actions based on the captured subsequent events;
sequencing the generated steps for reproducing the corresponding subsequent user actions including appending the generated steps to steps of the recording preceding the selected step; and
generating a new recording based on the sequenced generated steps including the steps for reproducing the subsequent actions.

20. The method of claim 3, wherein the browsing session includes closing a first browser instance associated with the browsing session while continuing capturing events associated with the identified browsing session.

21. The method of claim 1, wherein the one of the tasks that is not a browser task instance comprises a dialog window that is not generated by a browser associated with the browsing session.

22. A system configured to carry out the method of claim 3, wherein a thread of code configured to carry out capturing events and generating steps is running independently of any browser task instance associated with the browsing session.

23. A method for monitoring a browsing session executing on a computer system, comprising:
identifying a browsing session to be monitored;
capturing events associated with the identified browsing session;
analyzing the captured events to determine corresponding user actions associated with the browsing session;
generating steps for reproducing the corresponding user actions based on the captured events, including identifying a frame associated with at least one of the steps and identifying a nesting relationship of the identified frame with other frames associated with the browsing session;
sequencing the generated steps based on a sequence of occurrence of the corresponding user actions during the browsing session; and
generating a recording of the browsing session based on the sequenced steps.

24. A method for monitoring a browsing session executing on a computer system, comprising:
identifying a first browsing session to be monitored;
capturing events associated with the identified first browsing session, including capturing user input;
analyzing the captured events to determine corresponding user actions associated with the first browsing session;
generating steps for reproducing the corresponding user actions based on the captured events;
sequencing the generated steps based on a sequence of occurrence of the corresponding user actions during the first browsing session;
generating a recording of the first browsing session based on the sequenced steps;
executing a second browsing session using the recording;
capturing events associated with the second browsing session, including capturing user input;
selecting a level of detail for a transcript of the second browsing session, the level of detail designating ones of a plurality of categories of events associated with a browsing session that may be captured;
generating the transcript of the second browsing session by filtering the captured events associated with the second browsing session based on the determined level of detail, the transcript having a level of detail greater than the recording; and
utilizing the transcript to analyze performance of the recording.

25. The method of claim 24, wherein selecting a level of detail includes changing the level of detail while capturing events during the second browsing session.

26. The method of claim 24 further comprising executing a third browsing session using the recording, wherein a level of detail for a transcript of the third browsing session is selected that is different from the level of detail for the transcript for the second browsing session.

27. The method of claim 24, wherein utilizing the transcript includes editing at least one of the generated steps including reviewing the transcript of the captured events to determine what to edit in the at least one of the generated steps.

28. A method for monitoring a browsing session executing on a computer system, comprising:
identifying a browsing session to be monitored;
receiving a selection of one of a plurality of levels of detail for a transcript of the browsing session, the plurality of levels of detail designating different ones of a plurality of categories of events associated with a browsing session that may be captured;
capturing events associated with the identified browsing session, including capturing user input; and
generating the transcript of the browsing session by filtering the captured events associated with the identified browsing session based on the selected one of the plurality of levels of detail.

29. The method of claim 28, wherein receiving a selection of one of a plurality of levels of detail includes receiving a second selection of a different one of the plurality of levels of detail while capturing events during the identified browsing session.

30. The method of claim 28 further comprising identifying another browsing session to be monitored, wherein a level of detail for a transcript of the another browsing session is selected that is different from the one of the plurality of levels of detail.

31. A method for monitoring a browsing session executing on a computer system, comprising:
executing a browsing session using a recording including a plurality of sequenced steps for reproducing user actions;
stopping execution of the browsing session at a selected intermediate step of the recording;
resuming execution of the browsing session without use of the recording, including accepting user input;
capturing events associated with the resumed browsing session, including capturing the user input;
analyzing the captured events to determine corresponding user actions associated with the resumed browsing session;
generating steps for reproducing the corresponding user actions based on the captured events;
sequencing the generated steps based on a sequence of occurrence of the corresponding user actions during the resumed browsing session; and
generating an updated recording including appending the generated sequenced steps to ones of the plurality of sequenced steps for reproducing user actions preceding the selected intermediate step.

32. A method for reproducing a recorded browsing session on a computer system, comprising:
opening a main browser task instance for the browsing session;
sequentially executing steps for reproducing user actions included in a recording of the recorded browsing session using the main browser task instance;
receiving a command to open a second browser task instance for the browsing session and a command to close the main browser task responsive to execution of at least one of the steps; and
continuing sequentially executing the steps using the second browser task instance after closing the main browser task instance.

33. The method of claim 32 wherein sequentially executing, receiving and continuing sequentially executing are carried out by a thread of code running independently of the main browser task instance and the second browser task instance.

34. A method for monitoring a browsing session executing on a computer system, comprising:
opening a main browser task instance for a browsing session to be monitored;
capturing events associated with the identified browsing session;
detecting opening of a second browser task instance for the browsing session;
continuing capturing events associated with the identified browsing session after termination of the main browser task instance; and
generating a transcript of the captured events.

35. The method of claim 34, wherein opening a main browser task instance, capturing events, detecting opening of a second browser task instance and continuing capturing events are carried out by a thread of code running independently of the main browser task instance and the second browser task instance.

36. A system for monitoring a browsing session, comprising:
a recorder code module configured to initiate monitoring of the browsing session and to generate a sequence of steps for reproducing user actions based on captured events detected during monitoring of the browsing session;
a web manager code module configured to interact with browser task instances associated with the browsing session to detect the captured events during monitoring of the browsing session; and
at least one browser task instance associated with the browsing session, wherein the web manager code module and the recorder code module run independently of the at least one browser task instance.

37. The system of claim 36, further comprising:
a browser window handler code module operatively coupled to the at least one browser task instance and configured to detect windows opened by the at least one browser task instance and to report the detected windows to the web recorder code module; and
a dialog box handler code module configured to detect dialog boxes associated with and opened during the browsing session and to report the detected dialog boxes to the web recorder code module.

38. A computer system configured to carry out the method of claim 1.

39. A computer system configured to carry out the method of claim 23.

40. A computer program product for monitoring a browsing session executing on a computer system, the computer program product comprising computer program code embodied in a computer readable medium, the computer program code comprising program code configured to carry out the method of claim 1.

41. A computer program product for monitoring a browsing session executing on a computer system, the computer program product comprising computer program code embodied in a computer readable medium, the computer program code comprising program code configured to carry out the method of claim 23.

42. A computer program product for monitoring a browsing session, the computer program product comprising:
a computer readable medium having computer readable program code embodied therein, the computer readable program code comprising:
computer readable program code configured to identify a browsing session to be monitored;
computer readable program code configured to associate the browsing session with a process identifier of the operating system;
computer readable program code configured to capture events associated with the identified browsing session, including capturing user input received through tasks executing on the operating system having the associated process identifier, wherein at least one of the tasks is not a browser task instance; and
computer readable program code configured to generate a transcript of the captured events.
